(19) United States
(12) Patent Application Publication
(10) Pub. No.: US 2011/0247187 A1
(43) Pub. Date: Oct. 13, 2011

(54) Kit and method for converting strap/buckle securement to snap-on-off securement

(76) Inventor: Kris K. Smalley, Pittstown, NJ (US)

(21) Appl. No.: 12/798,681

(22) Filed: Apr. 9, 2010

(51) Int. Cl. B23P 17/04

(52) U.S. Cl. 29/401.1; 29/700

(57) ABSTRACT

A kit for converting a belt and buckle fastening system to a snap-on/snap-off system includes a keeper for retaining both a main portion of the belt opposing an end portion of the belt for captively retaining a snap hook having a slotted end secured at a bent over portion of the belt, with a screw installed through opposing buckle holes in the belt nearest to the bent over portion of the belt, for securing the retention of the snap hook on the belt for snapping onto and off of the buckle.

### FIELD OF THE INVENTION

The present invention relates generally to belt/strap and associated buckle securement systems, and more particularly to belt/strap securement systems providing rapid attachment and detachment of the belts or straps.

### BACKGROUND OF THE INVENTION

Animal blankets such as those for horses, dogs, and cats typically provide the securement of the blanket to the animal through use of belts or straps in combination with buckles. At times it can be particularly troublesome to quickly attach or detach a blanket to an animal using the standard belt/strap and buckle systems. For example, when fastening a blanket to a horse in cold winter weather one must typically remove their gloves to do so, causing one to “buckle-up” the many straps and buckles with frozen fingers and hands, contributing to lengthening the time it takes to complete the attachment. As a result, there has been a long felt need in the field for means to convert the strap and buckle systems associated with standard animal blankets, such as horse blankets, to permit rapid fastening of the blankets to an animal, even while wearing gloves in cold winter weather. Also, there is long felt need in the prior for converting a belt or strap and buckle securement systems to snap on/off securement systems for a myriad of other items besides animal blankets, such as horse blankets.

### SUMMARY OF THE INVENTION

An object of the invention is to provide a kit for converting a belt or strap and associated buckle securement system to a snap on and snap off securement system.

Another object of the invention is to provide a kit for permitting the conversion of the strap and buckle procurement systems of horse blankets to a snap-on/snap-off system.

Yet, another object of the invention is to provide a kit for permitting any item that is fastened with a belt or strap and buckle securement system to be converted to a system for permitting the straps to be connected together or detached from one another via a snap-on and snap-off system.

With these and other objects of the invention in mind, the present invention provides a conversion kit that includes at least one strap or belt keeper, a screw and locknut set, at least one snap hook, and at least one quick link.

A method for using the inventive conversion kit to convert a given strap/buckle securement means includes the following conversion steps:
(1) The keeper is installed from the strap or belt and moved passed the buckle hole that would be used to normally secure the belt to the buckle for fastening at least a particular portion of the blanket to a horse, for example, or to at least partially secure some other item;
(2) A snap buckle is installed by inserting the belt or strap through a strap slotway of the snap hook, and when a snap hook is moved to a position between the buckle hole that would normally be used and the next occurring more inward buckle hole;
(3) The free end of the belt or strap is then folded over to retain the snap hook, and fed through the keeper to the extent necessary to align the aforesaid typically used buckle hole with the next more inwardly occurring buckle hole'
(4) A flat edge screw is inserted through the aligned preexisting buckle holes directly behind the snap hook, while insuring in the application for a horse blanket, for example, that the flat end of the screw is positioned opposing the horse's body;
(5) A locknut is secured to the end of the screw protruding from the belt or strap, whereby in certain installations, the snap hook can now be snapped onto or off of the existing associated buckle; and
(6) In certain conversions, it is preferred to install a quick link through the blanket loop associated with the buckle, by first rotating a captive bridge nut in a direction to open the quick link to permit its installation on the buckle's blanket loop, followed by rotating the bridge nut in the opposite direction to close the quick link and insure that it remains on the blanket loop, whereafter the snap hook can then be snapped onto or snapped off the quick link.

The above illustrated steps for converting the strap and buckle fastenings for a horse blanket are not meant to be limiting, whereby the conversion kit can be utilized to convert any strap or belt and buckle system to a snap-on system.

### BRIEF DESCRIPTION OF THE DRAWINGS

Various embodiments of the invention are described below with reference to the drawings, in which like items are identified by the same reference designations, wherein:

FIG. 1 shows a front elevational view of a keeper for an embodiment of the invention;

FIG. 2 shows a front elevational view of another form of keeper relative to that of FIG. 1, for an alternative embodiment of the invention;

FIG. 3 shows a pictorial view of a one-half inch long screw for one embodiment of the invention;

FIG. 4 shows a pictorial view of a locknut for an embodiment of the invention;

FIG. 5 shows a pictorial view of a three-quarter inch long screw for an embodiment of the invention;

FIG. 6 shows a pictorial view of a quick link in an opened position for an embodiment of the invention;

FIG. 7 shows a pictorial view of the quick link of FIG. 6 in a closed position;

FIG. 8 shows a pictorial view for a snap hook for an embodiment of the invention; and

FIGS. 9 through 17 are pictorial views illustrating the various successive steps necessary for using the present inventive conversion kit to provide a method for converting a buckle strap fastening system to a strap-snap on/off fastening system.

### DETAILED DESCRIPTION OF THE INVENTION

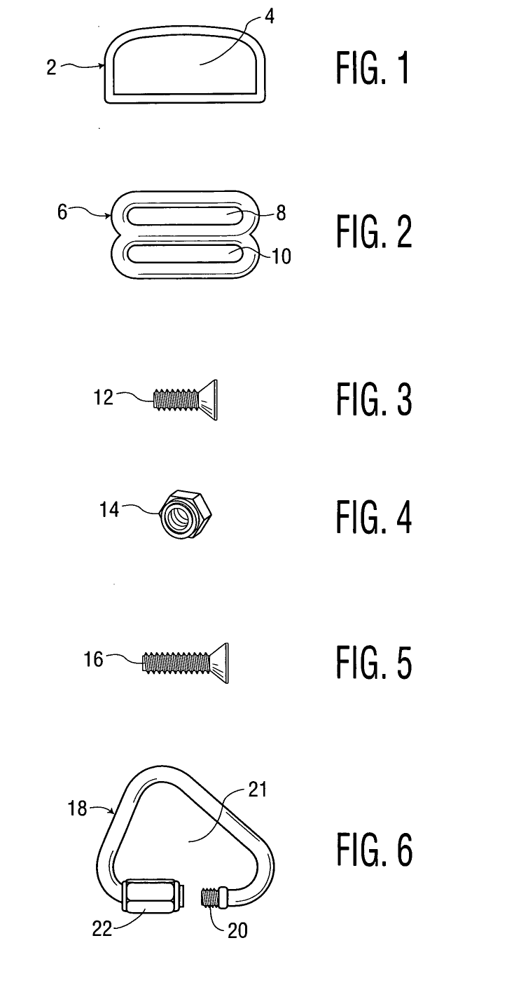

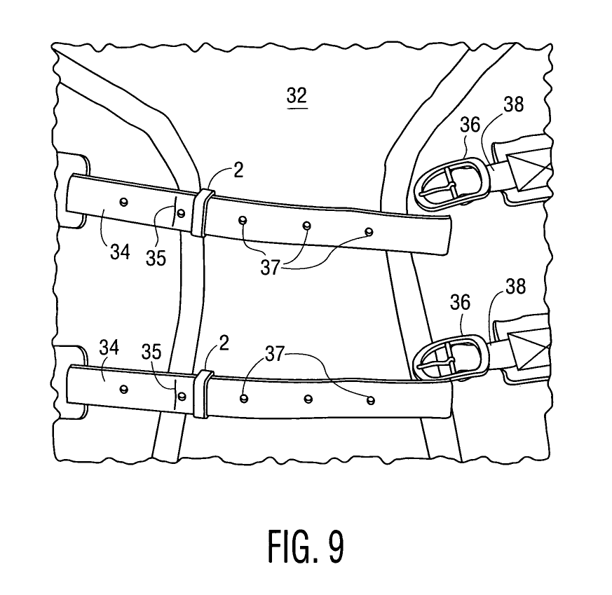

The present invention provides a kit of components for converting a strap or a belt and buckle fastening system into a snap-on/snap-off fastening system. The components required are shown in FIGS. 1 through 8, and are described in detail below. The method or steps required in using these components for converting a belt or a strap and buckle fastening system to a snap-on/snap-off system are shown in FIGS. 9 through 17, and are illustrated in association with a horse blanket initially provided with strap and buckle fastening system. However, the present invention is not limited to use in association with converting strap/buckle fastening systems of horse blankets, but can be used for converting any belt or strap and buckle fastening system to a snap-on/snap-off fastening or connection system.

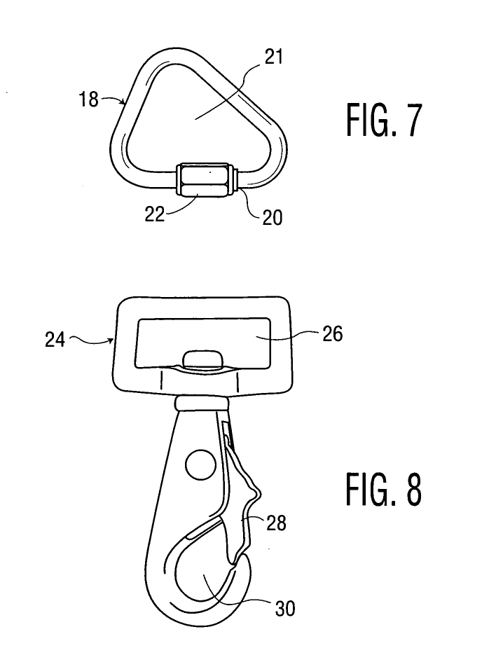

With reference to FIGS. 1 through 8, the conversion kit for the present invention includes one or more of each of the components shown, with the keeper of FIG. 2 and the quick link of FIGS. 6 and 7 being optional components, which nonetheless will typically be included in a kit for converting at least one belt and buckle combination to a snap-on/snap-off fastening system. The conversion kit can be provided with a plurality of such components for converting a plurality of belt or strap and buckle fastening systems to snap-on/snap-off fastening systems, respectively.

More specifically, the components for the present conversion kit, as shown in FIGS. 1 through 8, will now be described in detail. In FIG. 1, a belt or strap keeper 2 includes an open slot or slotway 4 for receiving a belt or strap. In FIG. 2, an alternative keeper 6 is shown that includes an upper belt slot 8, and a lower belt slot 10, as shown. In this example, FIG. 3 shows a one-half inch flat head screw, and FIG. 4 shows a locknut 14 for use in association with the screw of FIG. 3. An alternative longer screw, specifically a three-quarter inch flat head screw 16 is shown in FIG. 5, and is used instead of the shortest screw of FIG. 3, when necessary. The length shown for screws 12 and 16 are not meant to be limiting, and can be provided in other lengths depending upon the particular thicknesses of the belts or straps being converted to snap-on/snap-off fastening systems. Note that all of the components utilized in the conversion kit must be rust resistant, and are expected to be stainless steel, or provided by other suitable materials that are free from rust or other corrosive effects from use in an outdoor environment.

In FIG. 6, a quick link 18 is shown with its associated captive rotatable closure nut 22 located to a position for opening the link. In this example, the nut 22 is female threaded for mating with the opposing nut threaded free end 20 of the quick link 18, as shown. In FIG. 7 the closure nut 22 has been rotated to engage and be secured to the male threaded free end 20 for closing the quick link, as shown.

A snap hook 24 is shown in FIG. 8. The snap hook 24 includes at one end a belt slot 26, and at its opposing end a spring biased normally closed snap finger 28 for permitting the snap hook 24 to have its hook captive area 30 snap onto a section of a quick link 18, or a portion of a belt buckle, as will be further discussed below.

With further reference to FIGS. 1 through 8, and with reference to FIGS. 9 through 17, the method for using the present conversion kit to convert a strap and buckle fastening system to a quick snap-on/snap-off fastening will now be described. Note that for purposes of this illustration, wherever use of the term strap is used, it is meant to be synonymous with the term belt.

The first step in making the conversion is shown in FIG. 9, where a keeper 2 is installed via its belt slot 4 onto a perforated securement strap 34 of a horse blanket 32, in this example. The keeper 2 is slid down the strap 34 passed the buckle hole 37 normally used to secure the associated strap 34 to a buckle 36 secured to the end of a buckle strap 38, as shown. The keeper is further slid passed the next appearing inward buckle hole 37. Note that the line 35 is meant to show a wear line expected to be found in used horse blankets near the buckle hole 37 used for a particular horse, in this example.

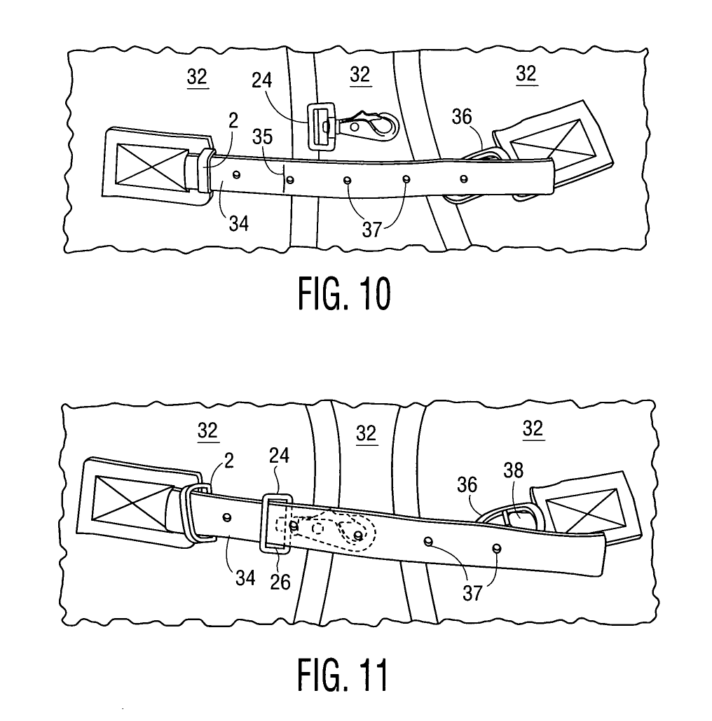

The second step is successively shown in FIGS. 10 and 11. In this step, the belt slot 26 of the snap hook 24 is installed on the strap 34 and slid to a position between the buckle hole 37 that would normally be used to fasten the strap to a buckle 36, to a position between the utilized buckle hole 37 and the next inward buckle hole 37, as shown. As indicated, if the horse blanket 32, in this example, has been previously used a number of times on a particular horse, wear marks 35 will be shown proximate used buckle hole 37, permitting rapid identification of the used hole 37. In the instance of a new horse blanket being converted, it must be first fitted on a horse via the strap 34 and associated buckle 36 in order to identify the buckle hole 37 of use, which can be marked via a pencil or pen for later identification when fitting the strap 34 and buckle 36 system to a snap-on/snap-off system via use of the present conversion kit.

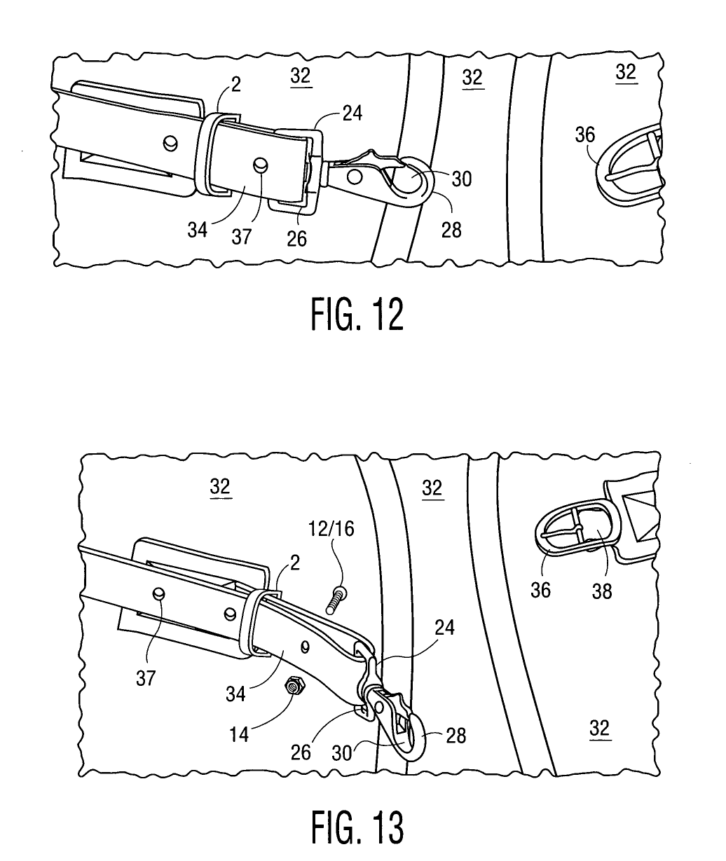

As shown in FIG. 12, the next step is to bend the free end of the strap 34 for captivating the snap hook 24, and passing the free end of strap 34 through the keeper 2 in a manner for aligning the normally used buckle hole 37 with the next inward occurring buckle hole 37, so that the two holes are opposing one another.

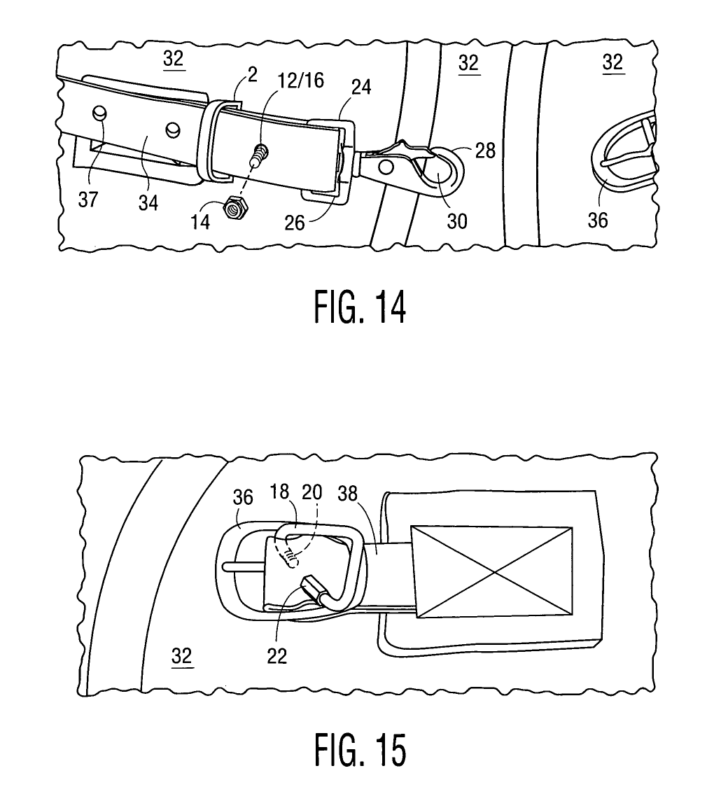

As shown in FIGS. 13 and 14, one of the screws 12 or 16, depending upon the thickness of the belt 34, are passed through the opposing buckle hole 37, with the head of screw 12 or 16 opposing the horse blanket 32, in this example, and the threaded end of the screw 12 or 16 protruding outward from the strap 34, as shown in FIG. 14.

With further reference to FIG. 14, the next step is to secure the locknut 14 onto the protruding end of the screw 12 or 16, as shown, and tighten the locknut 14 securely onto the screw 12 or 16. After completing this step, if desired, the snap hook 24 can be readily snapped onto the buckle 36, or snapped off, as desired. However, in a preferred embodiment of the invention, the next step is to install a quick link 18, as described immediately below.

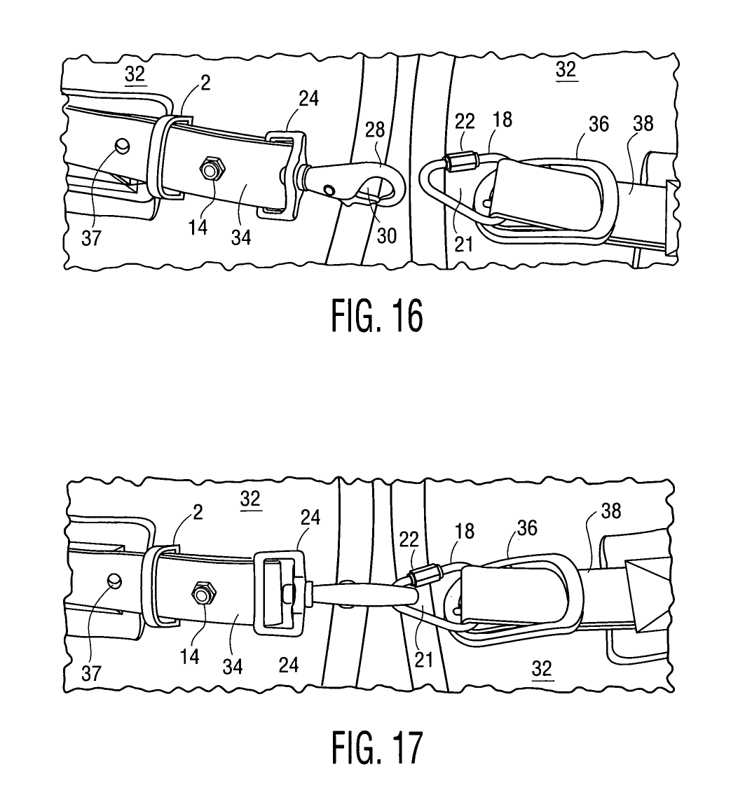

With reference to FIG. 15, a quick link 18 is opened by rotating the closure nut 22 in the appropriate direction, to obtain an open quick link 18, as shown in FIG. 6. The opening provided between the closure nut 22, and free end 20 of the quick link 18 is utilized to install the quick link 18 onto the folded-over portion of the buckle strap 38 retaining the buckle 36. After the quick link 18 is installed on the end of the buckle strap 38, the closure nut 22 is rotated in a direction to secure it to the male threaded free end 20 of the quick link 18, for closing the quick link 18 as shown in FIG. 7. FIG. 16 shows the completed installation of the quick link 18 onto the buckle strap 38. The snap hook 24 can then be snapped onto the quick link 18, as shown successively in FIG. 16 for initiating the connection, and in FIG. 17 for completing the snap-on connection. To remove the strap 34 from the strap 38, the snap hook 24 is simply snapped off the quick link 18, or the buckle 36 if the quick link 18 is not used, to provide a very rapid disconnect.

In the manner shown and described above, all of the straps 34 and their associated buckles 36 can be converted to a snap-on/snap-off system through use of a plurality of conversion kits of the present invention, or a single conversion kit that includes a plurality of the aforesaid components for permitting all of the strap 34/buckle 36 combination to be converted, such as found on a horse blanket 32, for example.

As indicated above, the present conversion kit includes an alternative keeper 6 as shown in FIG. 2. In certain applications, it may be desirable to use the alternative keeper 6 rather than the keeper 2 of FIG. 1. The only difference between using the keeper 6 rather than the keeper 2, is that initially the strap 34 is passed through one of the upper belt slot 8 or lower belt slot 10 of keeper 6 in the first step of conversion, followed by passing the strap through the other one of the slots 8 and 10 after the snap hook 24 has been installed on the strap 34, as described above.

If it is ever necessary to change the length of the above strap 34, if in this example, the horse blanket 32 is used to cover a different horse than previously covered, one merely must move the locknuts 14 and screw 12 or 16 to the necessary buckle holes 37, for lengthening or shortening strap 34. After the desired length is determined, the appropriate buckle holes 37 are aligned with one another, and the screw 12 or 16 is reinserted, and secured via locknut 14, as previously described.

Although various embodiments of the invention have been shown and described, they are not meant to be limiting. Those of skill in the art may recognize modifications to these embodiments, which modification are meant to be covered by the spirit and scope of the appended claims. For example, if a “custom hole” is desired in a belt strap 34 to obtain a better or “custom fit” for a horse blanket 32 or other article, before using the present kit, one can make or punch another hole in the desired location. After the hole is made, the kit is applied for use as described above. Also, the quick link 18 can be replaced by a rust-free heavy duty key ring.

What I claim is:

1. A kit for converting at least one belt and associated buckle fastening system to a snap-on/snap-off system, comprising:
at least one keeper including at least one belt slot;
at least one flat head screw, including a threaded stem;
at least one locknut;
at least one snap hook, including a belt slot;
the conversion being made by successive steps including:
said keeper being positioned via its belt slot on said belt inwardly past both a normally used buckle hole in said belt and an immediately inward next occurring buckle hole;
said snap hook being positioned on said belt via its belt slot between said normally used buckle hole and the immediately inward next occurring buckle hole;
said belt having a free end which is bent over and passed through the belt slot of said keeper for captively retaining said snap hook, and for aligning or placing in direct opposition said normally used buckle hole and said immediately inward next occurring buckle hole;
said screw having its stem inserted through the opposing buckle holes of said belt, with the flat head of said screw on an inward side of said belt, and the stem of said screw protruding from an outward side of said belt; and
said locknut being tightly secured to the protruding stem of said screw to insure said snap hook is captively secured to said belt, whereby said snap hook can now be snapped onto or off of said belt buckle.

2. The conversion kit of claim 1, further including:
a quick link having a closure nut rotatable in one direction for opening said link, and in another direction for closing said link, whereby said link is opened to install it onto a belt loop retaining said buckle, said link being closed for retaining it on the belt loop of said buckle, thereby permitting said snap hook to be snapped onto or off of said quick link rather than said buckle .

3. The conversion kit of claim 1, further including a plurality of said keepers, screws, locknuts, and snap hooks for converting a plurality of belt and buckle systems into a plurality of belt snap-on/snap-off systems, respectively.

4. The conversion kit of claim 1, wherein said at least one keeper further includes two belt slots, one slot for initial installation on said belt, the other slot for receiving the free end of said belt after installation of said snap hook on said belt.

5. A kit for converting a plurality of straps and associated plurality of buckles secured to associated individual belt loops, respectively, of a horse blanket, into a snap-on/snap-off system, comprising:
a plurality of keepers each including at least one strap receiving slot;
a plurality of flat head screws each including a threaded stem;
a plurality of locknuts; and
a plurality of snap hooks each including a strap receiving slot;
the conversion of at least one of said plurality of straps and its associated one of said plurality of buckles being made by successive steps including:
one of said plurality of keepers being positioned via its at least one receiving slot on said strap inwardly from the free end of said strap past both a normally used buckle hole and an immediately inward next occurring buckle hole;
one of said plurality of snap hooks being positioned on said strap via its strap slot between said normally used buckle hole and said immediately inward next occurring buckle hole;
said strap having its free end bent over and passed through the strap slot of said keeper for captively retaining said snap hook, and for aligning or placing in direct opposition said normally used buckle hole and said immediately inward next occurring buckle hole;
one of said plurality of screws having its stem inserted through the opposing buckle holes of said strap, with the flat head of said screw on an inward side of said strap opposing said horse blanket, and the stem of said screw protruding from an outward side of said strap; and
one of said plurality of locknuts being tightly secured to the protruding stem of said screw to insure said snap hook is captively secured to said strap, whereby said snap hook can now be snapped onto or off of the associated one of said plurality of buckles.

6. The conversion kit of claim 5, further including:
a plurality of quick links each having a closure nut rotatable in one direction for opening said link, and in another direction for closing said link, whereby said link is opened to install it onto a belt loop retaining said buckle, said link being closed for retaining it on the belt loop, thereby permitting said snap hook to be snapped onto or off of said quick link rather than said buckle.

7. The conversion kit of claim 5, wherein said plurality of keepers each further include two strap slots, one slot for initial installation on a strap, the other slot for receiving the free end of said strap after installation of a snap hook on said strap.

8. A method for converting at least one strap and associated buckle fastening system to a snap-on and snap-off system, comprising the steps of:
obtaining a keeper including at least one strap slot;
positioning said keeper via its strap slot on said strap inwardly past both a normally used buckle hole in said strap and an immediately inward next occurring buckle hole;
obtaining a snap hook including a strap slot;
positioning said snap hook via its strap slot between said normally used buckle hole and said immediately inward next occurring buckle hole of said strap;
bending over a free end of said strap and passing it through the strap slot of said keeper, for captively retaining said snap hook at the bent over portion of said strap, and for aligning in direct opposition said normally used buckle hole and said immediately inward next occurring buckle hole;
inserting a stem of a screw through the opposing buckle holes of said strap, with the stem of said screw protruding away from an outward side of said strap; and
installing and tightly securing a locknut onto the stem of said screw to insure said snap hook is captively secured to said strap, whereby said snap hook can now be snapped onto or off of said buckle.

9. The method of claim 8, further including the steps of:
obtaining a quick link having a closure nut rotatable in one direction for opening said quick link, and in another direction for closing said quick link;
opening said quick link to install it on a strap loop retaining said buckle; and
closing said quick link for captively retaining it on said strap loop, thereby permitting said snap hook to be snapped onto or off of said quick link rather than said buckle.

10. The method of claim 8, further including in said keeper obtaining step the obtainment of a keeper having two juxtaposed strap slots, one slot for initial installation on said strap, the other slot for receiving the free end of said strap after installation of said snap hook on said strap.
